(19) United States
(12) Patent Application Publication
(10) Pub. No.: US 2023/0089674 A1
(43) Pub. Date: Mar. 23, 2023

(54) STABILIZED SILANE COMPOSITION

(71) Applicant: Evonik Operations GmbH, Essen (DE)

(72) Inventors: Larissa Misslak, Weil am Rhein (DE); Kristine Walter, Reinheim (DE); Helmut Mack, Traunstein (DE)

(73) Assignee: Evonik Operations GmbH, Essen (DE)

(21) Appl. No.: 17/760,459

(22) PCT Filed: Feb. 9, 2021
(86) PCT No.: PCT/EP2021/053006

§ 371 Date: Aug. 10, 2022

(30) Foreign Application Priority Data
Feb. 14, 2020 (EP) 20157314.4

(51) Int. Cl. C08L 83/06; C08K 5/00

(52) U.S. Cl. CPC C08L 83/06; C08K 5/005

(57) ABSTRACT

A silane composition contains at least one iminosilane and at least one antioxidant. The at least one antioxidant is a sterically hindered phenol. A process can be used for the production of the silane composition.

The present invention relates to a silane composition, to a process for the production thereof and to the use of the silane composition according to the invention.

### BACKGROUND OF THE INVENTION

Iminosilanes are of major industrial interest and are used, inter alia, in the production of reactive formulations such as adhesives and sealants or coatings. Aminosilanes are nucleophilic and basic and, owing to their reactivity, often lead to undesirable secondary reactions in formulations (e.g. decrease in storage stability, increase in viscosity, discoloration). The use of iminosilanes in contrast enables these problems to be avoided or reduced and creates freedom in terms of formulation, particularly for one-component products. Iminosilanes are silanes comprising at least one imino function. An example of a product formulated with an iminosilane is a hybrid epoxide-based adhesive. The hybrid may be a silylated polyether (e.g. MS Polymer™), a silylated polyurethane (e.g. ST Polymer) or a silylated acrylate.

Another application example is the use of such iminosilanes in polymer applications, for example for modifying solution styrene-butadiene rubber (sSBR).

Despite the undisputed advantages and favourable properties, iminosilanes to date are only used in few products and formulations. This is especially due to the pronounced susceptibility to undesired color changes which accompanies increasing storage times for example, or which occur in the course of industrial processes. In particular, darkening, yellowing and color deepening occur as such undesirable color changes.

The undesirable color changes of these silanes are however a highly limiting disadvantage in terms of their use. In particular, since the color changes cannot easily be reversed and the colors then particularly also visually impair the products, formulations and surfaces to which the formulated product or the silane are applied.

This problem is known in the prior art but so far inadequately resolved. JP 2005-281158 A recommends the storage of such iminosilanes in an atmosphere with reduced oxygen content. Although reduction of the oxygen content can be achieved in laboratories usually with some technical effort, in standard industrial processes this is associated with much greater effort and in practice is usually not possible since no appropriate equipment is to hand or available. Particularly in the case of large containers from which only some of the iminosilane is to be withdrawn, the exclusion of oxygen and water is often linked to major technical hurdles and costs.

In addition, in the document cited above, reduction of the iron content and storage at reduced temperature is suggested in order to prevent yellowing of such silanes. However, these proposals also require the use of specific expensive equipment and complex processes, which in some cases can render the use of the silanes mentioned above impossible in existing industrial processes, particularly for reasons of cost.

U.S. Pat. No. 5,134,234 teaches curable compositions comprising polyisocyanates along with small amounts of iminosilanes and further additives like antioxidants. Antioxidants are also used for various applications. E.g. U.S. Pat. Nos. 8,877,955 and 9,708,429 report antioxidants to be employed in in polymer based composition.

US 2018/0016287 A1 proposes using Brønsted bases such as potassium hydroxide to stabilize iminosilanes. However, stabilizing with Brønsted bases is insufficient since the color changes cannot be prevented. On the contrary, addition of a Brønsted base sometimes even results in degradation of the iminosilane and thus to a reduced storage stability (see examples).

### OBJECT OF THE INVENTION

Therefore, the necessity exists of overcoming the disadvantages of the prior art.

In particular, there is a need to provide stabilized iminosilanes. In particular, iminosilanes are required which have less strong or ideally no undesirable color changes.

There is also a need for iminosilanes which can be used in standard industrial processes without complex and expensive storage conditions and handling.

### SUMMARY OF THE INVENTION

The objects of the present invention are achieved by the silane composition according to the invention comprising

a) at least one iminosilane; and

b) at least one antioxidant

characterized in that the at least one antioxidant is a sterically hindered phenol.

The silane composition according to the invention advantageously exhibits a significantly higher storage stability than the corresponding iminosilane alone or than the iminosilane in known formulations. In terms of the invention, storage stability signifies the stability of the iminosilane to undesirable chemical degradation over a defined time period. Surprisingly, this improved storage stability was shown even at elevated temperatures and independently of whether the silane composition according to the invention was stored under light or in the dark. The storage stability of the silane composition according to the invention is also particularly significantly improved on storage without exclusion of oxygen and water. This is particularly advantageous since complex methods for storage and handling can be avoided.

Advantageous embodiments of the silane composition according to the invention which are particularly good at addressing the objects of the present invention are listed in the following description and in the dependent claims.

### DESCRIPTION OF THE INVENTION

Percentages in the description and in the claims are percent by weight (abbreviated as % by weight), unless otherwise specified. Concentrations in the description and in the claims refer to the total mass or the total volume of the solution or dispersions or compositions in question, unless otherwise specified.

The various embodiments described below can be combined with one another if this is technically possible and nothing to the contrary is specified.

In the context of the present invention, the term “aliphatic” includes cyclic and acyclic (non-cyclic), saturated and unsaturated carbon compounds, wherein aromatic compounds are explicitly not included under this term (cf. Compendium of Technical Terminology, Gold Book, International Union of Pure and Applied Chemistry, 2014, Version 2.3.3, p. 57).

In the context of the present invention, the term “alkyl” includes branched and unbranched alkyl groups comprising cyclic and/or acyclic structural elements, wherein the cyclic structural elements necessarily comprise at least three carbon atoms. C1-CX-alkyl in the description and in the claims refers to alkyl groups comprising 1 to X carbon atoms (X is a natural number). C1-C8-alkyl includes, for example, methyl, ethyl, n-propyl, isopropyl, n-butyl, isobutyl, sec-butyl, tert-butyl, n-pentyl, isopentyl, sec-pentyl, tert-pentyl, neopentyl, hexyl, heptyl and octyl. An oxyalkyl group is an alkyl group which is attached to an oxygen atom. This is often referred to as an alkoxy group in the prior art. In the context of the invention, the term hydrogen also includes its isotopes such as deuterium.

An alkenyl group is an unsaturated analogue to an alkyl group which comprises one or more double bonds between two adjacent carbon atoms of the group. An alkenyl group necessarily comprises at least two carbon atoms.

The term “alkanediyl” refers to the analogue corresponding to the alkyl group having two bonding sites (instead of one in the case of the alkyl group). Alkanediyl groups are sometimes also called alkylene groups in the prior art. C1-C4-alkanediyl includes, for example, methane-1,1-diyl, ethane-1,2-diyl, ethane-1,1-diyl, propane-1,3-diyl, propane-1,2-diyl, propane-1,1-diyl, butane-1,4-diyl, butane-1,3-diyl, butane-1,2-diyl, butane-1,1-diyl and butane-2,3-diyl.

In the context of the invention, the term “aryl” includes annular aromatic molecular fragments (or groups), for example phenyl or naphthyl, in which one or more of the carbon atoms forming the ring can be replaced by N, O and/or S, such as in pyridyl for example. Preferably, none of the carbon atoms forming the ring are substituted by N, O and/or S, unless specified to the contrary.

In the context of the invention, combinations of alkyl and aryl are molecular fragments comprising both at least one alkyl group and at least one aryl group, i.e. aralkyl groups or alkaryl groups for example. Benzyl and tolyl are examples of such combinations.

Optionally, alkyl and aryl are functionalized. In this case, formally one or more hydrogen atoms of the named group are replaced in each case by a functional group, preferably by hydroxyl (—OH) and/or amino groups. Amino groups are primary (—NH₂), secondary (—NHR, where R is an organic radical such as an alkyl group or an aryl group) and tertiary amino groups (—NR₂, where each R is independently an organic radical).

If more than one radical has to be selected for a compound named in the claims or in the description—whether from one or more lists—, these radicals are selected independently of one another, unless otherwise specified. They may, if provided in the lists, therefore be the same or different.

If the term “at least one” is specified in the description and in the claims, this signifies that one or more than one of the named elements are selected. The same applies to higher numbers such as two or three.

If a compound can be included under more than one of the listed classes, this is appropriately classified in accordance with IUPAC. An appropriately substituted 4-aminophenol derivative, for example, could be classified either under aromatic amines or as a phenol. Since the oxygen-containing functional group is awarded higher priority, it is understood as a phenol derivative in the context of the present invention. If hydrogen is listed as substituent, its naturally occurring isotopes are thus also included. Bonding sites in chemical formulae are sometimes marked with a wavy line.

The silane composition according to the invention comprises at least one iminosilane. An iminosilane is a silane comprising at least one imino group. Examples of preferred iminosilanes are ketiminosilanes and aldiminosilanes.

Preferably, the iminosilane corresponds to an iminosilane according to formula (Z):

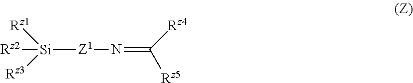

wherein

R^{z1}, R^{z2} and R^{z3} are each independently selected from the group consisting of oxime group, hydroxyl group, oxyalkyl group, oxyacyl group, oxyalkanediyloxyalkyl group, alkyl group, aryl group, enoxy group and (optionally) combinations of the aforementioned;

R^{z4} is selected from the group consisting of hydrogen, alkyl group, aryl group and combinations of alkyl group and aryl group;

R^{z5} is a monovalent organic group;

Z¹ is selected from the group consisting of divalent organic group and diorganylsilyl groups of the formula (Z2)

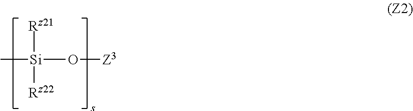

wherein

R^{z21} and R^{z22} are each independently selected from the group consisting of alkyl group, aryl group, oxyalkyl group and combinations of alkyl group and aryl group;

Z³ is a divalent organic group; and

s is an integer selected from 1, 2, 3, 4 and 5.

An enoxy group in this case is typically a group comprising an alkenyl group which is bonded via an oxygen atom to the silicon atom. Examples of enoxy groups are

—O—C(R^{L1})═CR^{L2}R^{L3},

where R^{L1}, R^{L2} and R^{L3} are independently selected from hydrogen and alkyl group, preferably from hydrogen and methyl group.

R^{z1}, R^{z2} and R^{z3} are preferably each independently selected from the group consisting of oxime group, hydroxyl group, oxyalkyl group, oxyacyl group, oxyalkanediyloxyalkyl group, alkyl group, aryl group, enoxy group. R^{z1}, R^{z2} and R^{z3} are more preferably each independently selected from the group consisting of hydroxyl group, oxyalkyl group, oxyacyl group and oxyalkanediyloxyalkyl group. R^{z1}, R^{z2} and R^{z3} are even more preferably each independently selected from the group consisting of oxy-C1-C4-alkyl group, acetoxy group (CH₃—C(O)—) and oxy-C1-C2-alkanediyloxy-C1-C2-alkyl group.

Example of oxy-C1-C2-alkanediyloxy-C1-C2-alkyl groups are CH₃—O—CH₂O—, CH—CH₂—O—CH₂—CH₂—O—, CH—CH₂O—CH₂O— and CH₃—O—CH₂—CH₂—O—.

R^{z4} is preferably selected from the group consisting of alkyl group, aryl group and combinations of alkyl group and aryl group. More preferably, R^{z4} is a C1-C4-alkyl group.

R^{z5} is preferably selected from the group consisting of alkyl group, aryl group and combinations of alkyl group and aryl group. More preferably, R^{z5} is a C1-C4-alkyl group.

Z¹ is preferably a divalent organic group. Preferably, this divalent organic group corresponds to:

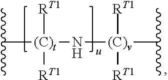

where t and v are independently selected integers from the interval of 1 to 6,

u is an integer selected from 0, 1, 2 and 3 and

each R^{T1} is each independently selected from the group consisting of hydrogen and methyl group.

Preferably, R^{T1} is hydrogen. In particular, Z¹ is:

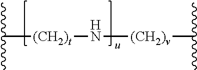

t and v are each independently preferably 2 or 3. u is preferably 0 or 1.

R^{z21} and R^{z22} are preferably each independently selected from the group consisting of C1-C4-alkyl group or oxy-C1-4-alkyl group.

Z³ is preferably an alkanediyl group, more preferably a C1-C8-alkanediyl group, still more preferably a C2-C4-alkanediyl group.

s is a preferably an integer selected from 2 and 3.

The at least one iminosilane is particularly preferably selected from the group consisting of

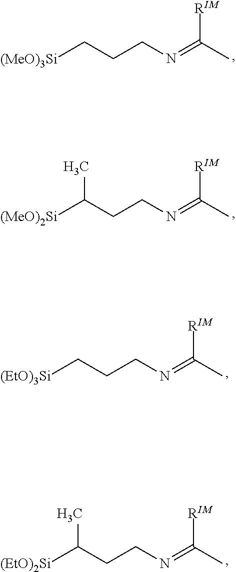

and mixtures of the aforementioned. R^{IM} is selected from isobutyl group, n-butyl group, sec-butyl group and tert-butyl group, preferably R^{IM} is an isobutyl group. The at least one iminosilane is especially preferably selected from the group consisting of

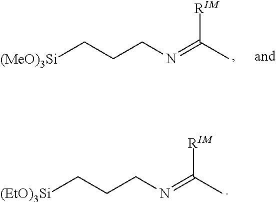

The amount of the at least one iminosilane in the silane composition is at least preferably is at least 80 weight-%, more preferably at least 90 weight-%, even more preferably at least 95 weight-%, yet even more preferably at least 99 weight-%. If more than one iminosilane is used, the total amount of all iminosilanes preferably lies in above-defined ranges.

The silane composition comprises at least one antioxidant. The at least one antioxidant is a sterically hindered phenol. The sterically hindered phenol as the at least one antioxidant gives a significantly improved prevention of the undesired color changes of the silane composition compared to other antioxidants, especially over a prolonged period of time (e.g. over 10 days or more). Other antioxidants such as sterically hindered amines, non-sterically hindered phenols, aromatic amines, organosulfur compounds, dialkylhydroxylamines, aliphatic phosphite compounds, phosphonite compounds and benzofuranones surprisingly were much less effective in preventing undesirable color changes when used as additives for iminosilanes.

Preferably, only one antioxidant is used since this facilitates the production of the silane composition and potential undesirable secondary effects of the various antioxidants can be avoided.

The sterically hindered phenol according to the invention is an aromatic compound comprising at least one benzene ring, which is functionalized with at least one hydroxyl group and which bears a substituent, which is not hydrogen (or an isotope thereof), at least one of the two ortho-positions relative to the at least one hydroxyl group. Preferably, both ortho-positions of the benzene ring relative to the at least one hydroxyl group are occupied by a substituent which is not hydrogen. Potential substituents include alkyl groups, aryl groups, thioether groups or similar.

The sterically hindered phenol preferably does not comprise any phosphorus atoms. In one embodiment, the sterically hindered phenol comprises no phosphorus atoms and no sulfur atoms. As a result, a further improvement in preventing undesired color changes is achieved.

The sterically hindered phenol preferably comprises at least one molecular unit selected from
molecular units of the formula (A1)

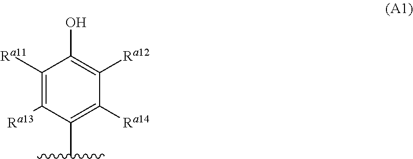

wherein
R^{a11}, R^{a12}, R^{a13} and R^{a14} are each independently selected from the group consisting of hydrogen, alkyl group, aryl group and combinations of alkyl group and aryl group,
wherein at least one of R^{a11} and R^{a12} is not hydrogen;
molecular units of the formula (A2)

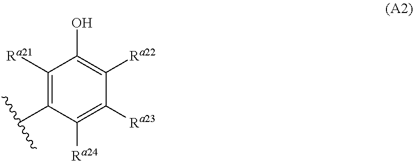

wherein
R^{a21}, R^{a22}, R^{a23} and R^{a24} are each independently selected from the group consisting of hydrogen, alkyl group, aryl group and combinations of alkyl group and aryl group,
wherein at least one of R^{a21} and R^{a22} is not hydrogen;
molecular units of the formula (A3)

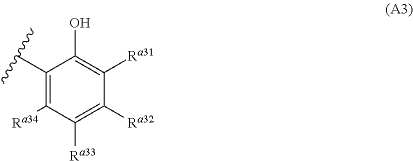

wherein
R^{a31}, R^{a32}, R^{a33} and R^{a34} are each independently selected from the group consisting of hydrogen, alkyl group, aryl group and combinations of alkyl group and aryl group; and
(optionally) combinations of the aforementioned.

Combinations of the aforementioned are sterically hindered phenols according to the invention comprising at least two different molecular units of the formulae (A1), (A2) and (A3). Such sterically hindered phenols are less preferred due to the comparatively high synthetic effort required for their preparation.

R^{a11} is preferably an alkyl group, more preferably a C1-C8-alkyl group, still more preferably a C2-C6-alkyl group, especially a tert-butyl group.

R^{a12} is preferably an alkyl group, more preferably a C1-C8-alkyl group, still more preferably a C2-C6-alkyl group, especially a tert-butyl group.

R^{a13} and R^{a14} are preferably selected from the group consisting of hydrogen and C1-C4-alkyl group, more preferably from hydrogen and methyl group. R^{a13} and R^{a14} are particularly preferably hydrogen. Preferably, at least one of R^{a11} and R^{a12} is an alkyl group, more preferably R^{a11} and R^{a12} are each independently alkyl groups.

In a preferred embodiment, the molecular unit of the formula (A1) corresponds to the formula (A1-1):

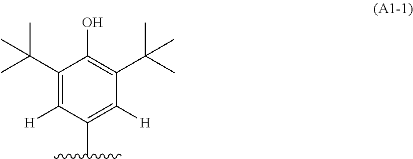

R^{a21} is preferably an alkyl group, more preferably a C1-C8-alkyl group, still more preferably a C1-C4-alkyl group, especially a methyl group.

R^{a22} is preferably an alkyl group, more preferably a C1-C8-alkyl group, still more preferably a C2-C6-alkyl group, especially a tert-butyl group.

R^{a23} is particularly preferably hydrogen.

R^{a24} is preferably an alkyl group, more preferably a C1-C8-alkyl group, still more preferably a C1-C4-alkyl group, especially a methyl group.

In a preferred embodiment, the molecular unit of the formula (A2) corresponds to the formula (A2-1):

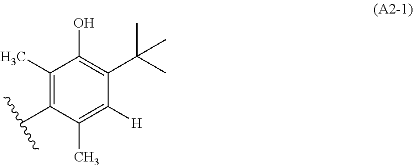

An especially preferred sterically hindered phenol comprising the molecular unit of the formula (A2) corresponds to formula (A2-2):

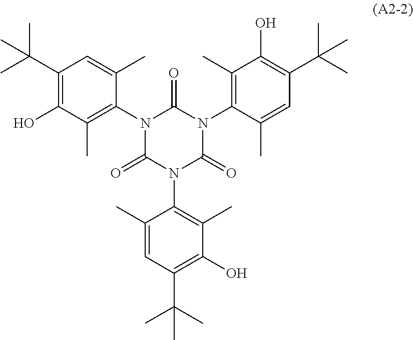

R^{a31} is preferably an alkyl group, more preferably a C8-C18-alkyl group, still more preferably a C10-C14-alkyl group, especially an n-dodecyl group.

R^{a32} and R^{a34} are preferably hydrogen.

R^{a33} is preferably an alkyl group, more preferably a C1-C8-alkyl group, still more preferably a C1-C4-alkyl group, especially a methyl group.

In a preferred embodiment, the molecular unit of the formula (A3) corresponds to the formula (A3-1):

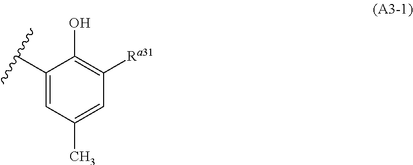

An especially preferred sterically hindered phenol comprising the molecular unit of the formula (A3) corresponds to formula (A3-2):

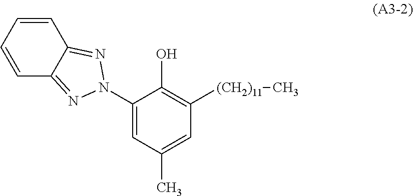

It is preferable that the sterically hindered phenol comprises at least one molecular unit of the formula (A1) or at least one molecular unit of the formula (A2). More preferably, the sterically hindered phenol comprises at least one molecular unit of the formula (A1). Therefore, the at least one antioxidant is especially preferably a sterically hindered phenol comprising at least one molecular unit of the formula (A1). Most preferably, the at least one antioxidant is a sterically hindered phenol comprising more than one molecular unit of the formula (A1), for example 2, 3 or 4. Such antioxidants exhibited the most pronounced improvements in storage stability and the prevention of undesirable color changes of all tested antioxidants. Surprisingly, the inventors found a synergistic effect: Even the use of a sterically hindered phenol with one molecular unit of the formula (A1), compared to a sterically hindered phenol with more than one molecular unit of the formula (A1) in an equivalent amount based on the amount of molecular units of the formula (A1), does not exhibit such a pronounced avoidance of undesirable color changes.

In a particularly preferred embodiment, the sterically hindered phenol is selected from the group consisting of 1,3,5-trimethyl-2,4,6-tris(3,5-di-tert-butyl-4-hydroxybenzyl)benzene (CAS No. 1709-70-2), 2,6-di-tert-butyl-4-methylphenol (also known as butylhydroxytoluene or BHT, CAS No. 128-37-0), pentaerythritol tetrakis(3-(3,5-di-tert-butyl-4-hydroxyphenyl)propionate) (also: pentaerythritol tetrakis(3,5-di-tert-butyl-4-hydroxyhydrocinnamate), CAS No. 6683-19-8), octyl 3,5-di-tert-butyl-4-hydroxyhydrocinnamate (CAS No. 125643-61-0), tert-butylhydroxyanisole (CAS No. 25013-16-5, as isomeric mixture, also known as BHA or as the pure substance 3-tert-butyl-4-hydroxyanisole), 2-tert-butylhydroquinone (CAS No. 1948-33-0, also known as TBHQ) and mixtures of the aforementioned.

The amount of the at least one antioxidant in the silane composition according to the invention is preferably in the range of 10 and 10 000 mg per kg (ppm, parts per million) of the at least one iminosilane. If it is intended to use more than one antioxidant, the sum total of the amounts of all antioxidants is in the range specified above. By analogy, it follows that the sum total of the amounts of all iminosilanes is used as reference value if more than one iminosilane is used. The amount of the at least one antioxidant is more preferably in a range of 50 to 1000 mg per kg, even more preferably 100 to 600 mg per kg of the at least one iminosilane. These amounts have proven to be particularly efficient for preventing undesirable color changes.

Amounts of antioxidant that are too high unnecessarily increase the costs and at the same time reduce the amount of iminosilane of which the use in industrial processes is desired. Amounts that are too low—depending on the iminosilane, the antioxidant and the storage conditions—do not always have a sufficient effect.

The silane composition according to the invention is preferably a homogeneous mixture. This means that the at least one iminosilane and the at least one antioxidant are dissolved in each other. Alternatively, the silane composition is a heterogeneous mixture. Homogeneous mixtures are preferred since better stability of the silane composition can be achieved by more thorough mixing of the components specified (iminosilane and antioxidant) and, in addition, also lower amounts of antioxidant are required in some cases in order to prevent undesired color changes.

The silane composition according to the invention preferably comprises one or more Brønstedt bases at a (total) concentration of at maximum 0.0001% by weight (based on the silane composition), more preferably of at maximum 0.00001% by weight. The silane composition according to the invention is particularly preferably free from Brønstedt bases since in some cases this can result in a lower storage stability of the silane composition (see examples). If the at least one iminosilane or the at least one antioxidant is a Brønstedt base, the silane composition according to the invention comprises no other Brønstedt base and no intentionally added Brønstedt base. Examples of Brønstedt bases, which in particular are not intended to be included in the silane composition according to the invention, are metal hydroxides such as alkali metal hydroxides and alkaline earth metal hydroxides (e.g. sodium hydroxide or potassium hydroxide), alkaline oxides such as alkaline earth metal oxides (e.g. calcium oxide, magnesium oxide, barium oxide), carbonates and hydrogencarbonates such as calcium carbonate and also metal alkoxides such as alkali metal alkoxides (e.g. sodium methoxide).

The silane composition according to the invention preferably comprises one or more Brønstedt acids at a (total) concentration of at maximum 0.0001% by weight (based on the silane composition), more preferably of at maximum 0.00001% by weight. The silane composition according to the invention is particularly preferably free from Brønstedt acids since it has been found in some cases by the inventors that this can result in an undesired decomposition of the iminosilane. If the at least one iminosilane or the at least one antioxidant is a Brønstedt acid, the silane composition according to the invention comprises no other Brønstedt acid and no intentionally added Brønstedt acid. Examples of Brønstedt acids are mineral acids such as sulfuric acid and hydrochloric acid and also organic acids such as citric acid and methanesulfonic acid.

The silane composition according to the invention preferably comprises heavy metals (particularly iron) or salts thereof at a concentration of at maximum 0.0001% by weight (based on the silane composition), more preferably of at maximum 0.00001% by weight. In particular, the silane composition according to the invention is free from (intentionally added) heavy metals or salts thereof. The silane composition according to the invention is particularly preferably free from iron and iron salts for the reasons presented above.

In a preferred embodiment, the silane composition according to the invention consists of

a) the at least one iminosilane; and

b) the at least one antioxidant.

In this preferred embodiment, the at least one antioxidant is used in the amount specified above and the remaining proportion of the silane composition is formed by the iminosilane.

In this preferred embodiment, the silane composition according to the invention preferably consists of
a) at least one iminosilane; and
b) at least one antioxidant in an amount of 10 to 10 000, preferably 50 to 1000, more preferably 100 to 600 mg per kg of the at least one iminosilane.

The at least one iminosilane forms the remaining portion of the silane composition.

The silane composition according to the invention is preferably stored in an inert atmosphere (with exclusion of oxygen and moisture (water)), whereby additional undesired color changes are avoided. Examples of inert atmospheres and use thereof are familiar to those skilled in the art, for example nitrogen or noble gases such as argon are used for this purpose, preferably also with exclusion of water. The present invention therefore also relates to a method for storing the silane composition according to the invention, preferably in an inert atmosphere. The silane composition according to the invention is typically stored in a closed container, for example in a flask, in a container or in a drum. However, it is a further advantage of the present invention that the silane composition according to the invention does not require to be stored under an inert atmosphere as it exhibits an improved stability under air (compared to prior art solutions and to the respective iminosilane itself, see table 2).

The silane composition according to the invention is preferably stored in a temperature range of 0 to 110° C., more preferably 5 to 30° C. This additionally prevents undesired color changes from occurring.

The silane composition according to the invention can also be used for all such applications in which the corresponding iminosilane is otherwise applicable. Typical applications include the use of the silane composition according to the invention in reactive formulations, for example in adhesives and sealants or coatings or in polymer applications.

In a further aspect, the present invention relates to a process for producing the silane composition according to the invention, comprising the process steps of
I) providing the at least one iminosilane;
II) providing the at least one antioxidant; and
III) mixing the at least one iminosilane and the at least one antioxidant,
such that the silane composition according to the invention is obtained.

The process steps are typically carried out in the sequence specified. Alternatively, process steps 1) and II) can be carried out in reverse sequence or simultaneously without disadvantage. The process according to the invention optionally includes further process steps which can be carried out before, during and/or after the process steps specified.

In process step 1), the at least one iminosilane is initially charged. Iminosilanes are generally commercially available or can be prepared by known methods. Methods for preparing iminosilanes are known to those skilled in the art, for example from US 2008/138522 A1 (paragraphs 31-94), US 2010/130764 A1 (paragraphs 3, 7-36), US 2013/281562 A1 (paragraphs 74-112) and US 2018/0016287 (paragraphs 34-88).

In one embodiment of the present invention, the at least one iminosilane is provided by a reaction of at least one aminosilane with at least one carbonyl compound.

The at least one aminosilane is preferably an aminosilane of the formula (X)

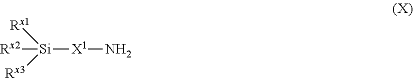

wherein

R^{x1}, R^{x2} and R^{x3} are each independently selected from the group consisting of oxime group, hydroxyl group, oxyalkyl group, oxyacyl group, oxyalkanediyloxyalkyl group, alkyl group, aryl group, enoxy group and combinations of the aforementioned; and

X¹ is selected from the group consisting of divalent organic group and diorganylsilyl groups of the formula (X2)

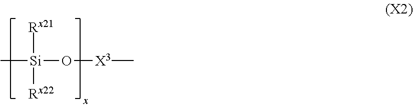

wherein
R^{x21} and R^{x22} are each independently selected from the group consisting of alkyl group, aryl group, oxyalkyl group and combinations of alkyl group and aryl group;
X³ is a divalent organic group; and
x is an integer selected from 1, 2, 3, 4 and 5.

R^{x1}, R^{x2} and R^{x3} are preferably each independently selected from the group consisting of oxime group, hydroxyl group, oxyalkyl group, oxyacyl group, oxyalkanediyloxyalkyl group, alkyl group, aryl group, enoxy group. R^{x1}, R^{x2} and R^{x3} are more preferably each independently selected from the group consisting of hydroxyl group, oxyalkyl group, oxyacyl group and oxyalkanediyloxyalkyl group. R^{x1}, R^{x2} and R^{x3} are even more preferably each independently selected from the group consisting of oxy-C1-C4-alkyl group, acetoxy group and oxy-C1-C2-alkanediyloxy-C1-C2-alkyl group.

X¹ is preferably a divalent organic group. Preferably, this divalent organic group corresponds to:

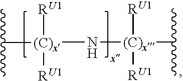

where x′ and x′″ are independently selected integers from the interval of 1 to 6,

x″ is an integer selected from 0, 1, 2 and 3

and each R^{U1} is independently selected from the group consisting of hydrogen and methyl group. Preferably, R^{U1} is hydrogen.

In particular, X¹ is:

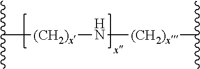

x′ and x′″ are each independently preferably 2 or 3. x″ is preferably 0 or 1.

R^{x21} and R^{x22} are preferably each independently selected from the group consisting of C1-C4-alkyl group or oxy-C1-C4-alkyl group.

X³ is preferably an alkanediyl group, more preferably a C1-C8-alkanediyl group, still more preferably a C2-C4-alkanediyl group.

x is preferably an integer selected from 2 and 3.

Particularly preferred aminosilanes are selected from the group consisting of trialkoxysilylpropylamines and dialkoxyalkylsilylpropylamines. Even more preferably, aminosilanes are selected from the group consisting of (3-aminopropyl)trimethoxysilane (AMMO, CAS No. 13822-56-5), (3-aminopropyl)triethoxysilane (AMEO, CAS No. 919-30-2), 3-aminopropyl(dimethoxy)methylsilane (CAS No. 3663-44-3), 3-aminopropyl(diethoxy)methylsilane (CAS No. 3179-76-8) and mixtures of the aforementioned.

The at least one carbonyl compound preferably corresponds to a carbonyl compound of the formula (Y):

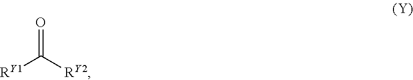

wherein

R^{Y1} is selected from the group consisting of hydrogen, alkyl group, aryl group and combinations of alkyl group and aryl group; and

R^{Y2} is a monovalent organic group.

R^{Y1} is more preferably selected from the group consisting of alkyl group, aryl group and combinations of alkyl group and aryl group. Even more preferably, R^{Y1} is a C1-C4-alkyl group.

R^{Y2} is more preferably selected from the group consisting of alkyl group, aryl group and combinations of alkyl group and aryl group. Even more preferably, R^{Y2} is a C1-C4-alkyl group.

Typically, the reaction of the at least one aminosilane and the at least one carbonyl compound is carried out at a temperature in the range of 70 to 130° C. The duration is based on the reactants used and is generally selected up to the most complete conversion of the reactants as possible; typically, 2 to 5 hours is sufficient. A person skilled in the art can find further parameters in the documents cited above.

Depending on the reaction regime and the at least one aminosilane and the at least one carbonyl compound, a person skilled in the art can optionally subject the reaction mixture resulting from the reaction of the at least one aminosilane and the at least one carbonyl compound to a purification. A person skilled in the art knows common purification methods and applies these accordingly. Preferably, the resulting water together with the carbonyl compound, particularly if used in excess, is removed from the reaction mixture by distillation, and the resulting anhydrous iminosilane is then purified by distillation, for example by being distilled off from the reaction mixture via the overhead.

In the case of the provision of the at least one iminosilane by the reaction described above of the at least one aminosilane with the at least one carbonyl compound with subsequent purification, the antioxidant is added to the reaction mixture prior to purification, during purification or after purification. If the at least one antioxidant is added to the at least one iminosilane after purification, it is ideally added directly after purification is complete, for example within one day, better within a few hours, still better within five minutes of completion of purification. Undesirable color changes are thus immediately avoided. It is particularly advantageous to purify the resulting or resultant iminosilane by distillation and for the at least one antioxidant to be present in the storage vessel such that the iminosilane purified by distillation mixes with it immediately after distillation.

The at least one antioxidant in process step II) is generally commercially available or can be synthesized by common standard methods well known to those skilled in the art.

In process step III), the at least one iminosilane and the at least one antioxidant are mixed, whereupon the silane composition according to the invention is obtained. Methods for mixing the two specified components are known to those skilled in the art and can be adjusted to the respective requirements by routine tests.

For example, initially charging the two components in a glass beaker is suitable, with subsequent stirring with, for example, a magnetic stirrer bar, at room temperature and with exclusion of moisture and oxygen, until a preferably homogeneous mixture of the two components has formed. This mixture is the silane composition according to the invention. Alternatively, the two components specified can be mixed with each other in a stirred tank. For this purpose, one of the two can be initially charged and the other can be added or both can be added with mixing.

Process step III) is preferably carried out under an inert atmosphere (i.e. with exclusion of water and oxygen), which also improves storage stability and avoids undesirable color changes.

The silane composition according to the invention is used, for example, as chain terminating reagent in polymerization reactions, such as in anionic polymerization reactions, or (preferably) as adhesion-promoting additive in adhesives and sealants.

In a further aspect, the present invention relates to a process for applying an adhesive or sealant formulation comprising the silane composition according to the invention onto a surface, comprising the process steps of:

A) providing a surface,

B) applying the adhesive or sealant formulation comprising the silane composition according to the invention to the surface,

such that a coated surface is obtained.

Adhesives and sealants are generally known in the art as well as process parameters for their applications on surfaces.

The present invention is elucidated in more detail by the examples which follow, without limiting the subject matter.

### EXAMPLES

Commercial products are used as in the technical bulletins available at the time of the filing of this application, unless stated otherwise. The following was used in all tests as iminosilane:

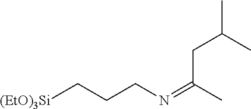

The following antioxidants were used in the tests:

| | | |
|---|---|---|
| Antioxidant 1 | 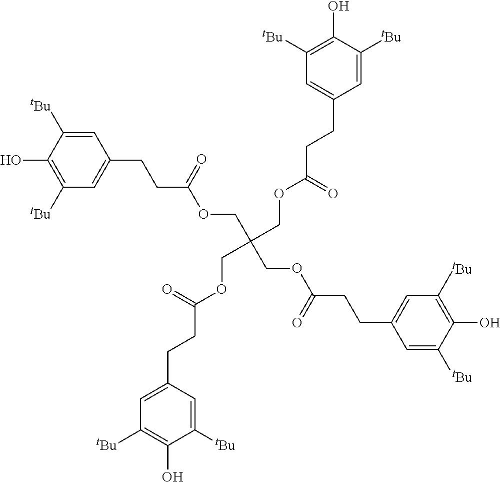 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O] | Sterically hindered phenol having four molecular units of the formula (A1) |
| Antioxidant 2 | 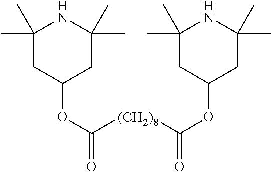 | Sterically hindered amine |
| Antioxidant 3 | didodecyl 3,3′-thiodipropionate (CAS no. 123-28-4) | Sulfur-containing antioxidant |
| Antioxidant 4 | 3,9-bis(octadecyloxy)-2,4,8,10-tetraoxa-3,9-diphosphaspiro[5.5]undecane | Phosphite compound |
| | (CAS no. 3806-34-6) | |

### Preparation of the Silane Compositions According to the Invention

The iminosilane was weighed into a 0.1 l square brown glass flask under nitrogen on a precision balance. The antioxidant was weighed by difference into a weighing boat on an analytical balance. Prior to the addition of the antioxidant, a syringe was filled with the iminosilane using a disposable pipette in order to rinse the antioxidant completely from the weighing boat into the 0.1 l square brown glass flask. During the rinsing, the liquid was maintained continuously under a dry nitrogen flow.

After the addition, by means of a magnetic stirrer bar and a magnetic stirrer plate, the antioxidant was mixed into the iminosilane under a dry nitrogen atmosphere in the 0.1 l square brown glass flask until dissolution was complete.

After the antioxidant had completely dissolved, ca. 15 g of the sample were filled into a scintillation vial using a disposable pipette. The sample was filled under ambient air atmosphere and sealed under air contact.

The samples were prepared analogously with KOH (250 mg per kg of the iminosilane).

### Storage of the Silane Compositions:

The silane compositions were stored as follows:

Samples filled under ambient air atmosphere were stored at 60° C. in the drying cabinet, cooled to room temperature for withdrawal of an analytical quantity, the scintillation vials were opened and the samples stirred for 5 minutes under ambient air atmosphere. Subsequently, a sample amount was taken for analysis using a disposable pipette. Subsequently, the sample was again stored at 60° C. in the drying cabinet under ambient air atmosphere until the next sample withdrawal. The storage times are listed in each case in the following Tables 1 and 2.

### Determination of the Iminosilane Content by Gas Chromatography (GC):

To determine the iminosilane content, a sample of the silane compositions was investigated by gas chromatographic analysis. For this purpose, an “Agilent 6890” instrument from Agilent was used with a column of the “Ultra-2/HP5 (5% phenyl methylsiloxane)” type (length: 25.0 mm, diameter: 320.00 μm). The injection amount was 0.4 μL. The instrument was operated at an injector temperature of 250° C. and a detector temperature of 280° C. The following temperature program was used: 100° C. for 2 min, heating to 275° C. at a heating rate of 10° C. per minute and maintaining the final temperature for a further 20 minutes.

### Determination of the Color Number of the Silane Compositions:

The color number was determined with a “LICO 690” spectral photometer from Hach Lange. Color numbers were determined both in the range of the platinum-cobalt color scale and in the range of the Gardner color scale.

For all measurements, a sample of the liquid silane composition was filled into a measuring cuvette and the transmission determined with the aid of the spectral photometer (0°/180° geometry). For the determination of the color number in the range of the platinum-cobalt color scale, the procedure was in accordance with DIN EN ISO 6271-2:2004. For the determination of the color number in the range of the Gardner color scale, the procedure was in accordance with DIN EN ISO 4630:2015.

TABLE 1
Color changes (color number in [mg Pt Co/I] or [Gardner]) of the silane compositions or of the iminosilane
as a function of time and of the antioxidant.

| | Storage duration in days under | | |
|---|---|---|---|
| | ambient air atmosphere (B) | | |
| Antioxidant | 0 | 5 | 10 |
| None (comparative) | 35 mg Pt Co/I | 555 mg Pt Co/I | 9 Gardner |
| KOH (comparative) | 8 Gardner | 7 Gardner | 10 Gardner |
| Antioxidant 1 (inventive) | 40 mg Pt Co/I | 210 mg Pt Co/I | 472 mg Pt Co/I |
| Antioxidant 2 (comparative) | 40 mg Pt Co/I | 145 mg Pt Co/I | 5 Gardner |
| Antioxidant 3^{a} (comparative) | 25 mg Pt Co/I | 6 Gardner | 17 Gardner |
| Antioxidant 4^{a} (comparative) | 30 mg Pt Co/I | 620 mg Pt Co/I | 8 Gardner |

^{a}based on a freshly prepared batch of iminosilane having a color number of 25 mg Pt Co/I initially

On storage under ambient air atmosphere, the silane composition according to the invention exhibited a lower color deepening, i.e. improved avoidance of undesired color changes, than the iminosilane (comparative example). Some comparative anti-oxidants even resulted in faster color changes compared to the iminosilane alone (antioxidants 3 and 4). The use of antioxidant in the silane composition according to the invention showed the lowest color change by far overtime. It can be seen that only the silane composition according to the invention gives a long-term effect of avoiding undesired color changes. The use of KOH as additive resulted in an immediate and permanent color deepening.

TABLE 2
Proportions of the original iminosilane used (in area %) as a function of time and possible
additives, determined by GC

| | Storage duration in days under | | |
|---|---|---|---|
| | ambient air atmosphere (B) | | |
| Antioxidant | 0 | 5 | 10 |
| None (comparative) | 94.9 | 91 | 87 |
| KOH (comparative) | 93.4 | 91.5 | 85.0 |
| Antioxidant 1 (inventive) | 94.6 | 92.2 | 90.5 |
| Antioxidant 2 (comparative) | 94.7 | 92.3 | 89 |

On storage under ambient air atmosphere, the silane compositions comprising antioxidants had a slower decline in purity than the iminosilane. However, only the silane composition according to the invention allowed for a more long-lasting effect with regard to inhibiting the undesirable chemical degradation. When using comparative antioxidants (antioxidant 2), the chemical degradation of the iminosilane can only be prevented for a short period of time. The use of KOH as additive in the silane composition results in an immediate and permanent decrease in purity.

1. A silane composition, comprising:
at least one iminosilane; and
at least one antioxidant,
wherein the at least one antioxidant is at least one sterically hindered phenol.

2. The silane composition according to claim 1, wherein the at least one sterically hindered phenol comprises at least one molecular unit selected from the group consisting of
a molecular unit of the formula (A1): 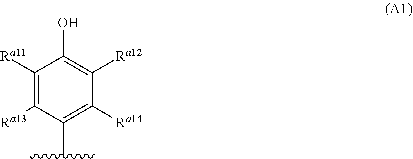
wherein R^{a11}, R^{a12}, R^{a13} and R^{a14} are each independently selected from the group consisting of hydrogen, alkyl group, aryl group, and a combination of alkyl group and aryl group,
wherein at least one of R^{a11} and R^{a12} is not hydrogen;
a molecular unit of the formula (A2): 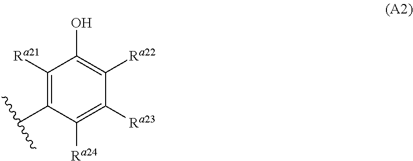
wherein R^{a21}, R^{a22}, R^{a23} and R^{a24} are each independently selected from the group consisting of hydrogen, alkyl group, aryl group, and a combination of alkyl group and aryl group,
wherein at least one of R^{a21} and R²² is not hydrogen;
a molecular unit of the formula (A3): 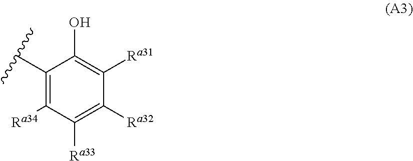
wherein R^{a31}, R^{a32}, R^{a33} and R^{a34} are each independently selected from the group consisting of hydrogen, alkyl group, aryl group, and a combination of alkyl group and aryl group; and
a combination of the aforementioned.

3. The silane composition according to claim 2, wherein the at least one antioxidant is a sterically hindered phenol comprising at least one molecular unit of the formula (A1).

4. The silane composition according to claim 3, wherein the at least one sterically hindered phenol comprises more than one molecular unit of the formula (A1).

5. The silane composition according to claim 4, wherein the at least one sterically hindered phenol comprises 2, 3 or 4 molecular units of the formula (A1).

6. The silane composition according to claim 1, wherein the at least one sterically hindered phenol does not comprise any phosphorus atoms.

7. The silane composition according to claim 1, wherein the at least one sterically hindered phenol comprises no phosphorus atoms and no sulfur atoms.

8. The silane composition according to claim 1, wherein the at least one sterically hindered phenol is at least one selected from the group consisting of 1,3,5-trimethyl-2,4,6-tris(3,5-di-tertbutyl-4-hydroxybenzyl)benzene, 2,6-di-tert-butyl-4-methylphenol, pentaerythritol tetrakis(3-(3,5-di-tert-butyl-4-hydroxyphenyl)propionate), octyl 3,5-di-tert-butyl-4-hydroxyhydrocinnamate, tert-butylhydroxyanisole, 2-tert-butylhydroquinone, and a mixture of the aforementioned.

9. The silane composition according to claim 1, wherein an amount of the at least one antioxidant is in a range of 10 to 10,000 mg per kg of the at least one iminosilane.

10. The silane composition according to claim 1, wherein the at least one iminosilane is an iminosilane according to formula (Z): 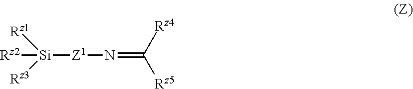
wherein
R^{z1}, R^{z2} and R^{z3} are each independently selected from the group consisting of oxime group, hydroxyl group, oxyalkyl group, oxyacyl group, oxyalkanediyloxyalkyl group, alkyl group, aryl group, enoxy group, and a combination of the aforementioned;
R^{z4} is selected from the group consisting of hydrogen, alkyl group, aryl group, and a combination of alkyl group and aryl group;
R^{z5} is a monovalent organic group;
Z¹ is selected from the group consisting of a divalent organic group and a diorganylsilyl group of the formula (Z2): 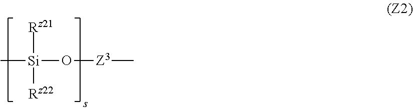
wherein
R^{z21} and R^{z22} are each independently selected from the group consisting of alkyl group, aryl group, oxyalkyl group, and a combination of alkyl group and aryl group;
Z³ is a divalent organic group; and
s is an integer from 1, 2, 3, 4, or 5.

11. The silane composition according to claim 10, wherein the at least one iminosilane is at least one selected from the group consisting of 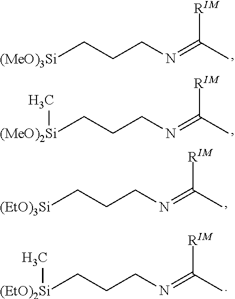
and
a mixture of the aforementioned,
wherein R^{IM} is selected from the group consisting of isobutyl group, n-butyl group, sec-butyl group, and tert-butyl group.

12. The silane composition according to claim 1, wherein the silane composition comprises one or more Brønsted bases at a concentration of at maximum 0.0001% by weight.

13. A process for producing the silane composition according to claim 1, comprising:
providing the at least one iminosilane;
providing the at least one antioxidant; and
mixing the at least one iminosilane and the at least one antioxidant, such that the silane composition is obtained.

14. A polymerization method, comprising:
conducting a polymerization reaction with a chain terminating reagent comprising the silane composition according to claim 1.

15. A process for applying an adhesive or sealant formulation comprising the silane composition according to claim 1 onto a surface, the process comprising:
providing a surface, and
applying the adhesive or sealant formulation comprising the silane composition to the surface, such that a coated surface is obtained.

16. The silane composition according to claim 9, wherein the amount of the at least one antioxidant is in a range of 50 to 1,000 mg per kg of the at least one iminosilane.

17. The silane composition according to claim 9, wherein the amount of the at least one antioxidant is in a range of 100 to 600 mg per kg of the at least one iminosilane.
